(19) United States
(12) Patent Application Publication
(10) Pub. No.: US 2023/0139753 A1
(43) Pub. Date: May 4, 2023

(54) HEATING MEMBER OF ATOMIZING DEVICE WITH DIFFERENT HEATING EFFECTS AT DIFFERENT PORTIONS AND ATOMIZING DEVICE

(71) Applicant: SHENZHEN HUACHENGDA DEVELOPMENT CO., LTD, Shenzhen, Guangdong (CN)

(72) Inventor: Xiaodie Wang, Shenzhen, Guangdong (CN)

(21) Appl. No.: 17/918,559

(22) PCT Filed: Mar. 29, 2021
(86) PCT No.: PCT/CN2021/083623

§ 371 Date: Oct. 12, 2022

(51) Int. Cl. A24F 40/46; A24F 40/10; A24F 40/485

(52) U.S. Cl. CPC A24F 40/46; A24F 40/10; A24F 40/485

(57) ABSTRACT

The invention provides a heating member of an atomizing device with different heating effects at different portions and an atomizing device. The heating member is tubular and includes electrode portions and a heating circuit portion. The heat per unit time of the radial side A of the heating member is less than that of another side B. The atomizing device includes the heating member and a liquid conducting member. When the heating member is applied in the atomizing device, the airflow can pass by the side B, so that no large temperature difference exists, thereby improving the smoke flavor, and preventing the carbon deposition due to high temperature. Besides, the liquid can enter the liquid conducting member from the gap at the side A, thereby avoiding the scorched flavor caused by insufficient liquid supply due to long liquid flow path caused by the liquid feeding at the two ends.

### FIELD

The present invention relates to the technical field of electrical heating, and more specifically, to a heating member of an atomizing device with different heating effects at different portions and an atomizing device.

### BACKGROUND

Referring to FIG. 1, in the atomization technology, a heating assembly is usually composed of a heating member and a liquid conducting member, and the liquid conducting member transmits the liquid to the heating member for heating and atomizing. The liquid conducting member generally adopts a liquid conducting cotton or a porous ceramics, and the heating member generally adopts a heating wire wound around the outer periphery of the liquid conducting cotton rope. Such a heating assembly is typically used in an electronic cigarette to heat and atomize smoke liquid, and the airflow will bring the smoke out through the heating assembly. However, there are problems: either a scorched flavor is easily produced, or the taste of the smoke cannot come out, or a carbon deposit is easily formed to affect the service life.

### SUMMARY

A technical problem to be solved by the present invention is, in view of the above defects, to provide a heating member of an atomizing device with different heating effects at different portions and an atomizing device.

A technical solution adopted by the present invention to solve the technical problem includes: providing a heating member of an atomizing device with different heating effects at different portions, configured to heat and atomize liquid, being tubular and with a radial dimension between 1 mm and 17 mm, an axial dimension between 2 mm and 33 mm, and a wall thickness between 0.02 mm and 0.9 mm, wherein the heating member includes two electrode portions respectively disposed at two ends in the axial direction and a heating circuit portion electrically connected between the two electrode portions, the heating circuit portion includes a group of first connecting portions, a group of second connecting portions, a group of third connecting portions and a group of fourth connecting portions disposed sequentially in the circumferential direction, the group of first connecting portions includes a plurality of first connecting portions spaced along the axial direction, the group of second connecting portions includes a plurality of second connecting portions spaced along the axial direction, the group of third connecting portions includes a plurality of third connecting portions spaced along the axial direction, and the group of fourth connecting portions includes a plurality of fourth connecting portions spaced along the axial direction; and

the axial dimensions of the first connecting portion and the third connecting portion are larger than the axial dimensions of the second connecting portion and the fourth connecting portion, each first connecting portion connects two adjacent second connecting portions and two adjacent fourth connecting portions, each third connecting portion connects two adjacent second connecting portions and two adjacent fourth connecting portions, so that the first connecting portions, the second connecting portions and the third connecting portions are connected to form a first circuit, and the third connecting portions, the fourth connecting portions and the first connecting portions are connected to form a second circuit, and the first circuit is connected in parallel with the second circuit, and when the electrode portions are powered on, the first circuit and the second circuit generate heat, and the heat of a radial side of the heating member per unit time is less than that of another radial side of the heating member per unit time.

Preferably, the first connecting portions are disposed on an axial side, and the second connecting portions, the third connecting portions and the fourth connecting portions are disposed on another side, a circumferential sectional area of the first connecting portion is larger than a circumferential sectional area of the third connecting portion, a circumferential dimension of the first connecting portion is larger than circumferential dimensions of the second connecting portion, the third connecting portion and the fourth connecting portion, and the heat of the first connecting portions per unit time is less than the heats of the second connecting portions, the third connecting portions and the fourth connecting portions per unit time.

Preferably, from the middle to two ends of the heating member, the circumferential dimensions of the first connecting portions are equal, the circumferential dimensions of the second connecting portions are equal, and the circumferential dimensions of the fourth connecting portions are equal; or, the circumferential dimensions of the first connecting portions increase, the circumferential dimensions of the second connecting portions decrease, and the circumferential dimensions of the fourth connecting portions decrease; or, the circumferential dimensions of the first connecting portions decrease, the circumferential dimensions of the second connecting portions increase, and the circumferential dimensions of the fourth connecting portions increase.

Preferably, the first connecting portion is provided with a liquid inlet hole communicating the inside with the outside.

Preferably, a circumferential dimension of the second connecting portion is larger than a circumferential dimension of the fourth connecting portion, and the heat of the second connecting portions per unit time is smaller than the heat of the fourth connecting portions per unit time.

Preferably, axial dimensions of the second connecting portion and the fourth connecting portion are equal.

Preferably, the second connecting portion and the fourth connecting portion are respectively disposed on two radial sides of the heating member, an axial dimension of the second connecting portion is smaller than an axial dimension of the fourth connecting portion, a spacing between the second connecting portions is less than a spacing between the fourth connecting portions, and the heat of the second connecting portions per unit time is less than that of the fourth connecting portions per unit time.

Preferably, circumferential dimensions of the second connecting portion and the fourth connecting portion are equal.

Preferably, circumferential dimensions of the first connecting portion and the third connecting portion are smaller than those of the second connecting portion and the fourth connecting portion.

Preferably, circumferential dimensions of each second connecting portion, each fourth connecting portion, each first connecting portion, and each third connecting portion are equal.

Preferably, the first connecting portion and the third connecting portion are staggered in the axial direction.

Preferably, the heating circuit portion is connected to the two electrode portions through the third connecting portion.

The technical solution adopted by the present invention to solve the technical problem includes: providing an atomizing device, including the above heating member, and further including a housing and a liquid conducting member; wherein the liquid conducting member is disposed in the heating member, the housing is provided with a liquid passage and an air inlet passage therein, the liquid passage and the air inlet passage are communicated to two radial sides of the heating member respectively, and the heat of the side of the heating member communicated to the liquid passage per unit time is less than the heat of the side of the heating member communicated to the air inlet passage per unit time.

The technical solution adopted by the present invention to solve the technical problem includes: providing an atomizing device, including the above heating member, and further including a housing and a liquid conducting member; wherein the liquid conducting member is disposed in the heating member with two ends in the axial direction extending out of the heating member, the housing is provided with a liquid passage and an air inlet passage therein, the liquid passage is communicated to the two ends of the liquid conducting member, and the air inlet passage is communicated to a radial side of the heating member, and the heat of the side of the heating member communicated to the air inlet passage per unit time is larger than the heat of another side of the heating member.

Implementation of the technical solution of the present invention provides at least the following beneficial effects: the heat of the side A of the heating member per unit time is less than the heat of another side B of the heating member per unit time. When the heating member is applied in an atomizing device such as an electronic cigarette, the airflow may be enabled to pass by the side B, so that there is no problem of large temperature difference, thereby improving the smoke flavor, and preventing the carbon deposition due to high temperature. In addition, the liquid can enter the liquid conducting member from the gap at the side A, which can avoid the scorched flavor caused by insufficient liquid supply due to long liquid flow path caused by the liquid feeding at the two ends.

### BRIEF DESCRIPTION OF THE DRAWINGS

Subject matter of the present invention will be described in even greater detail below based on the exemplary figures. In the accompanying drawings:

FIG. 1 is a stereoscopic view of a heating member and a liquid conducting member of the background technology;

FIG. 2 is a right side view of the heating member and the liquid conducting member in FIG. 1 (wherein the arrows indicate the direction of air flow);

FIG. 3 is a stereoscopic view of a heating member in a first embodiment of the present invention;

FIG. 4 is a schematic diagram of the heating member of FIG. 3 expanded along the dotted line in FIG. 3;

FIG. 5 is a circuit diagram of the heating member of FIG. 4 (dotted lines indicate the first circuit and the second circuit);

FIG. 6 is a stereoscopic view of a heating member in a second embodiment of the present invention;

FIG. 7 is a schematic diagram of the heating member of FIG. 6 spreading along the dotted line in FIG. 6.

FIG. 8 is a circuit diagram of the heating member of FIG. 7 (wherein the dotted lines indicate a first circuit and a second circuit);

FIG. 9 is a perspective view of a heating member in a third embodiment of the present invention;

FIG. 10 is a front view of the heating member of FIG. 9;

FIG. 11 is a schematic diagram of the heating member of FIG. 10 spreading along the dotted line in FIG. 10;

FIG. 12 is a circuit diagram of the heating member of FIG. 11 (wherein the dotted lines indicate a first circuit and a second circuit);

FIG. 13 is a perspective view of a heating member in a fourth embodiment of the present invention;

FIG. 14 is a schematic diagram of the heating member of FIG. 13 expanded along the dotted line in FIG. 13;

FIG. 15 is an expanded diagram of a heating member in a fifth embodiment of the present invention;

FIG. 16 is a perspective view of a heating member in a sixth embodiment of the present invention;

FIG. 17 is a schematic diagram of the heating member of FIG. 16 expanded along the dotted line in FIG. 16;

FIG. 18 is an expanded diagram of a heating member in a seventh embodiment of the present invention;

FIG. 19 is an exploded view of an atomizing device in an embodiment of the present invention;

FIG. 20 is a sectional view of the atomizing device of FIG. 13 (wherein the arrows indicate the flow direction of liquid);

FIG. 21 is another sectional view of the atomizing device of FIG. 13 (wherein the arrows indicate the direction of air flow);

FIG. 22 is an exploded view of an atomizing device in another embodiment of the present invention;

FIG. 23 is a sectional view of the atomizing device of FIG. 16 (wherein the arrows indicate the flow direction of the liquid);

FIG. 24 is another sectional view of the atomizing device of FIG. 16 (wherein the arrows indicate the direction of air flow).

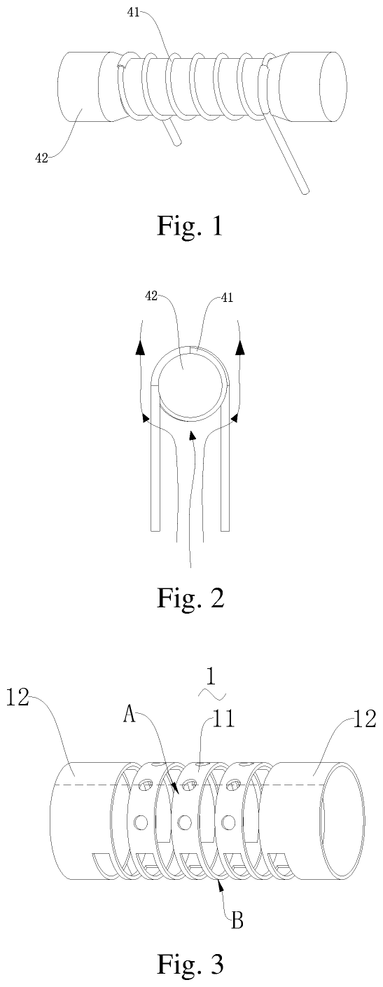

Wherein, the reference marks in the drawings represent: heating member 1, heating circuit portion 11, first connecting portion 111, liquid inlet hole 1111, second connecting portion 112, third connecting portion 113, fourth connecting portion 114, first circuit 11a, second circuit 11b, electrode portion 12, side A with less heat per unit time, side B with more heat per unit time, liquid conducting member 2, housing 3, liquid passage 31, air inlet passage 32, air outlet passage 33, liquid storage chamber 34, heating member 41 in background technology, and liquid conducting member 42 in background technology.

### DETAILED DESCRIPTION

For better understanding of the technical features, objects and effects of the present invention, the specific embodiments of the present invention will be described in detail with reference to the accompanying drawings. It should be understood that the orientation or the position relationship indicated by relative terms such as “front”, “back”, “upper”, “lower”, “left”, “right”, “longitudinal”, “lateral”, “vertical”, “horizontal”, “top”, “bottom”, “inner”, “outer”, “head”, and “tail” should be construed to refer to the orientation or the position relationship as then described or as illustrated in the drawings under discussion. These relative terms are for convenience of description and do not require that the present invention be constructed or operated in a particular orientation. It should be further noted that, in the present invention, unless specified or limited otherwise, the terms “mounted”, “connected”, “coupled”, “fixed”, “arranged”, “disposed” and the like are used broadly, and can be, for example, fixed connection, detachable connection, or integral connection; can also be direct connection or indirect connection via an intervening medium; can also be inner communication of two elements or interaction between two elements. When one element is described to be “located on” or “located below” another element, it means that the element can be “directly” or “indirectly” located on another element, or there may be one or more intervening elements located therebetween. The terms “first”, “second”, “third” and the like are only used for the convenience of describing the technical solution, and cannot be understood as indicating or implying the relative importance or implicitly indicating the number of the indicated technical features. Therefore, features defined with “first”, “second”, “third”, etc. may explicitly or implicitly indicates that one or more of these features can be included. For those of ordinary skill in the art, the specific meaning of the above-mentioned terms in the present invention can be understood according to specific circumstances.

In the description hereinbelow, for purposes of explanation rather than limitation, specific details such as specific systematic architectures and techniques are set forth in order to provide a thorough understanding of the embodiments of the present invention. However, it will be apparent to persons skilled in the art that the present invention may also be implemented in absence of such specific details in other embodiments. In other instances, detailed descriptions of well-known systems, devices, circuits, and methods are omitted so as not to obscure the description of the present invention with unnecessary detail.

As shown in FIG. 2, according to the research, the problems mentioned in the background technology, i.e., either the smoke flavor is not good, or a carbon deposit is easily formed to affect the service life, is caused because that the heating member 41 generates heat in full circumferential direction, and the difference in heat in all circumferential direction is small, but the intake air flows through the lower half-circle portion of the heating member 41, the heat in the upper half-circle portion will be more than that in the lower half-circle portion, thereby causing uneven temperature distribution (that is, the temperature in the upper half-circle portion is higher than that in the lower half-circle portion). In this regard, the present invention provides an improved heating member for an atomizing device with different heating effects for different portions. As for the problem of the scorched flavor, the reason is that the existing heating assembly generally adsorbs liquid from the two ends of the liquid conducting member 41, and the liquid enters the middle position from the two ends of the liquid conducting member 41, resulting in a long liquid flow path, thereby insufficient liquid supply is easy to occur to produce scorched flavor when the heating assembly continues heating.

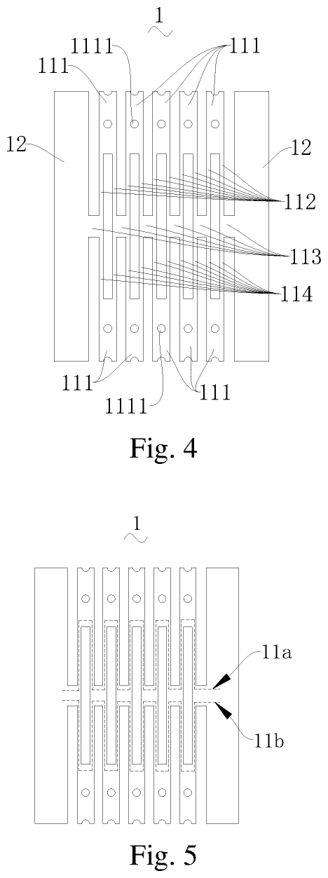

Referring to FIGS. 3 to 5, a heating member 1 of an atomizing device with different heating effects at different portions in one embodiment of the present invention, configured to heat and atomize liquid, is tubular in overall shape, with a radial dimension of 1 mm to 17 mm, an axial dimension of 2 mm to 33 mm, and a wall thickness of 0.02 mm to 0.9 mm. The heating member 1 may be in a shape of circular tube or square tube. For the square tube, the radial dimension refers to the width and the height, and the axial dimension refers to the length. The heating member with these dimensions usually has a suitable resistance and a good heating effect. The heating member 1 includes two electrode portions 12 disposed at two ends in the axial direction and a heating circuit portion 11 electrically connected between the two electrode portions 12. The heating circuit portion 11 includes a group of first connecting portions 111, a group of second connecting portions 112, a group of third connecting portions 113 and a group of fourth connecting portions 114 disposed sequentially in the circumferential direction. The group of first connecting portions 111 includes a plurality of first connecting portions 111 spaced along the axial direction, the group of second connecting portions 112 includes a plurality of second connecting portions 112 spaced along the axial direction, the group of third connecting portions 113 includes a plurality of third connecting portions 113 spaced along the axial direction, and the group of fourth connecting portions 114 includes a plurality of fourth connecting portions 114 spaced along the axial direction.

The axial dimensions of the first connecting portion 111 and the third connecting portion 113 are larger than those of the second connecting portion 112 and the fourth connecting portion 114. Each first connecting portion 111 connects two adjacent second connecting portions 112 and two adjacent fourth connecting portions 114, and each third connecting portion 113 connects two adjacent second connecting portions 112 and two adjacent fourth connecting portions 114, so that the first connecting portions 111, the second connecting portions 112 and the third connecting portions 113 are connected to form a first circuit 11a, and the third connecting portions 113, the fourth connecting portions 114 and the first connecting portions 111 are connected to form a second circuit 11b, and the first circuit Ila is connected in parallel with the second circuit 11b. When the electrode portions 12 are powered on, the first circuit 11a and the second circuit 11b generate heat, and the heat of the side A in the radial direction of the heating member 1 per unit time is less than the heat of the other side B in the radial direction of the heating member 1 per unit time.

The heating circuit portion 11 may be formed by hollowing out, and preferably, the heating member 1 is integrated.

When the heating member 1 is applied to the atomizing device, the liquid conducting member 2 may be installed in the heating member 1. The liquid conducting member 2 conducts the liquid to the heating member 1 for heating and atomizing, and the airflow brings out the atomized gas through the heating member 1. When the atomizing device is an electronic cigarette, the heating member 1 heats and atomizes the smoke liquid in the electronic cigarette.

The heating surface of the heating member 1 is concentrated on the side B, and the other side A has little or no heat. When the heating member 1 is applied to the atomizing device such as the electronic cigarette, the airflow can pass by the side B, so that there is no problem of large temperature difference, thereby improving the smoke flavor, and preventing the carbon deposition due to high temperature. In addition, the liquid can enter the liquid conducting member 2 from the gap at the side A, which can avoid the scorched flavor caused by insufficient liquid supply due to long liquid flow path caused by the liquid feeding at the two ends.

In some embodiments, referring to FIGS. 3 to 5, the electrode portion 12 is annular around an axis of the heating member 1. In other embodiments, the electrode portion 12 is in a convex shape in the axial or radial direction.

In some embodiments, referring to FIGS. 3 to 5, the first connecting portion 111 is disposed at the axial side A. The second connecting portion 112, the third connecting portion 113 and the fourth connecting portion 114 are disposed at the other side B. The sectional area of the first connecting portion 111 is larger than the circumferential sectional area of the third connecting portion 113, and the circumferential dimension of the first connecting portion 111 is larger than the circumferential dimensions of the second connecting portion 112, the third connecting portion 113 and the fourth connecting portion 114. Since having a large sectional area and a small resistance, the heat value per unit time is smaller, therefore, the heat value per unit time of the first connecting portion 111 is less than that of the second connecting portion 112, the third connecting portion 113 and the fourth connecting portion 114, so that the heat value of the radial side A of the heating member 1 is less than that of the other side B per unit time.

Referring to FIGS. 3 to 5, preferably, from the middle to the two ends of the heating member 1, the circumferential dimensions of the first connecting portions 111 are equal, the circumferential dimensions of the second connecting portions 112 are equal, the circumferential dimensions of the fourth connecting portions 114 are equal, and the circumferential dimension of the second connecting portion 112 is equal to the circumferential dimension of the fourth connecting portion 114.

Refer to FIGS. 3 to 5, preferably, the first connecting portion 111 is provided with a liquid inlet hole 1111 that runs through the inside and the outside. When the heating member 1 is applied to the atomizing device, the liquid can enter the liquid conducting member 2 from the side of the first circuit 11a, the liquid inlet hole 1111 can improve the liquid inlet efficiency to achieve more sufficient liquid supply.

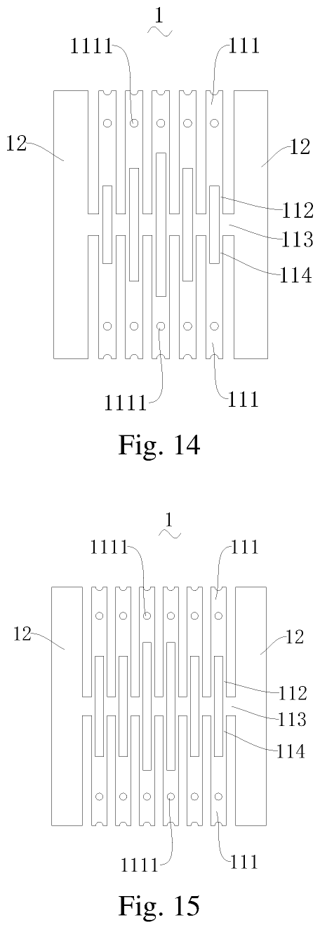

Referring to FIGS. 13 to 14, the dimensions of the connecting portion of the heating member 1 may alternatively be that, from the middle to the two ends of the heating member 1, the circumferential dimensions of the first connecting portions 111 increase, the circumferential dimensions of the second connecting portions 112 decrease, and the circumferential dimensions of the fourth connecting portions 114 decrease. The circumferential dimension changes of the first connecting portion 111, the second connecting portion 112 and the fourth connecting portion 114 may be gradual (see FIGS. 13 to 14) or staged (see FIG. 15). When the heating member 1 is applied to the atomizing device, the liquid can enter the liquid conducting member 2 from the side of the first circuit 11a. According to the heat radiation principle, the temperature in the middle portion is high, the air inlet is also in the middle of the heating member 1, and the heating area in this embodiment is concentrated in the middle of the heating member. In this way, the middle portion has a larger heating atomization area and a larger air flow, which can achieve the effect of heat balance.

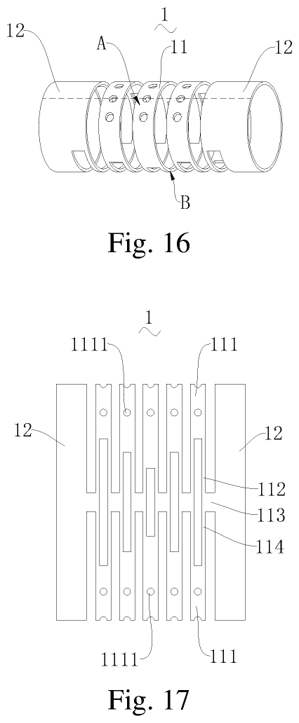

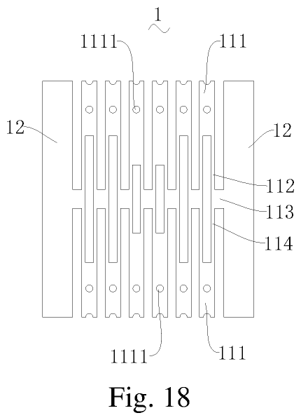

Referring to FIGS. 16 to 17, the dimensions of the connecting portion of the heating member 1 may alternatively be that, from the middle to the two ends of the heating member 1, the circumferential dimensions of the first connecting portions 111 decrease, the circumferential dimensions of the second connecting portions 112 increase, and the circumferential dimensions of the fourth connecting portions 114 increase. The circumferential dimension changes of the first connecting portion 111, the second connecting portion 112 and the fourth connecting portion 114 may be gradual (see FIGS. 16 to 17) or staged (see FIG. 18). When the heating member 1 is applied to the atomizing device, the liquid feeding method of feeding the liquid from the axial two ends to the middle of the heating member may be adopted. Because the heating circuit in the middle portion of the heating member in this embodiment is shorter, and the circuits at the two ends are longer (correspondingly, the atomization area in the middle is smaller, and the atomization areas at the two ends are larger), so as to be better matched with the liquid feeding distance to achieve a balanced effect, thereby avoiding the possibility that the liquid supply in the middle portion of the heating member 1 is insufficient to cause a core burning due to the high heat and the remote liquid supply of the middle portion.

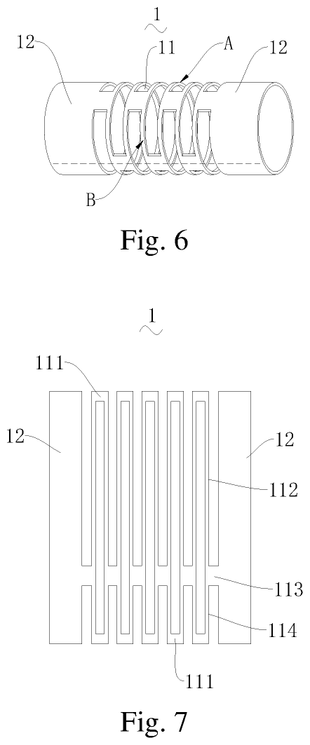

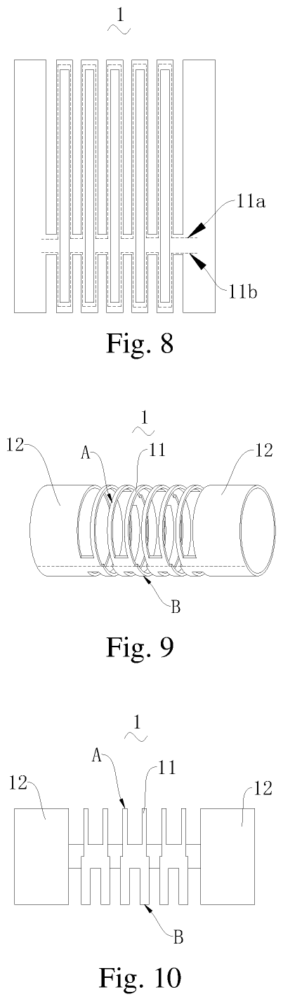

In some embodiments, referring to FIGS. 6 to 8, the circumferential dimension of the second connecting portion 112 is larger than the circumferential dimension of the fourth connecting portion 114, and the heat value of the second connecting portions 112 per unit time is less than that of the fourth connecting portions 114 per unit time, so that the heat value of the radial side A of the heating member 1 per unit time is less than that of the radial side B per unit time.

Referring to FIGS. 6 to 8, preferably, the axial dimension of the second connecting portion 112 is equal to that of the fourth connecting portion 114. In this way, the heating trajectory of the first circuit 11a is far longer than that of the second circuit 11b, so that the resistance of the first circuit 11a is far larger than that of the second circuit 11b, while the first circuit 11a and the second circuit 11b are parallel circuits and the voltages at the two ends of the circuits are the same, so according to I=U/R, the current of the first circuit 11a is far less than that of the second circuit 11b. So, according to power P=I² R=UI, the power of the first circuit 11a is far less than that of the second circuit 11b, so that the heat of the first circuit 11a is far less than that of the second circuit 11b.

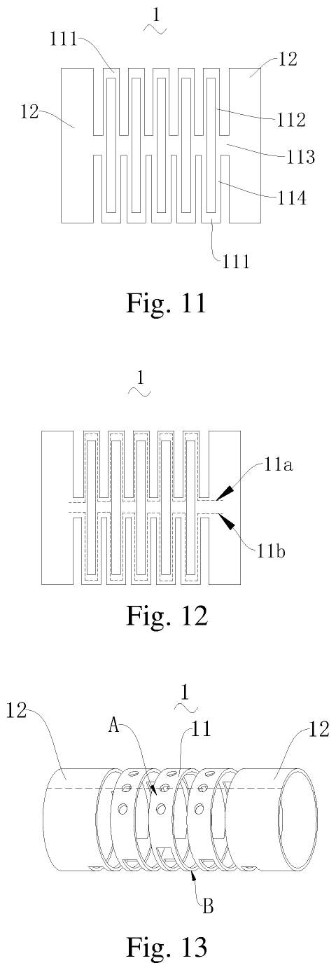

In some embodiments, referring to FIGS. 9 to 12, the second connecting portion 112 and the fourth connecting portion 114 are respectively disposed on two sides of the heating member 1 in the radial direction. The axial dimension of the second connecting portion 112 is less than the axial dimension of the fourth connecting portion 114, and the spacing between the second connecting portions 112 is larger than the spacing between the fourth connecting portions 114, the heating value of the second connecting portions 112 per unit time is less than that of the fourth connecting portions 114 per unit time, so that the heating value of the radial side A of the heating member 1 per unit time is less than that of the radial side B per unit time.

Referring to FIGS. 9 to 12, preferably, the circumferential dimensions of the second connecting portion 112 and the fourth connecting portion 114 are equal.

In the above embodiments of FIGS. 6 to 12, preferably, the circumferential dimensions of the first connecting portion 111 and the third connecting portion 113 are smaller than those of the second connecting portion 112 and the fourth connecting portion 114.

In the above technical solution, preferably, the circumferential dimensions of each second connecting portion 112 are equal, the circumferential dimensions of each fourth connecting portion 114 are equal, the circumferential dimensions of each first connecting portion 111 are equal, and the circumferential dimensions of each third connecting portion 113 are equal. The thicknesses of each portion of the heating member 1 are equal, that is, the radial dimensions of each portion of the heating member 1 are equal.

In the above technical solutions, preferably, the first connecting portion 111 and the third connecting portion 113 are staggered in the axial direction.

In the above technical solutions, preferably, the heating circuit portion 11 is connected to the two electrode portions 12 through the first connecting portion 111 or the third connecting portion 113.

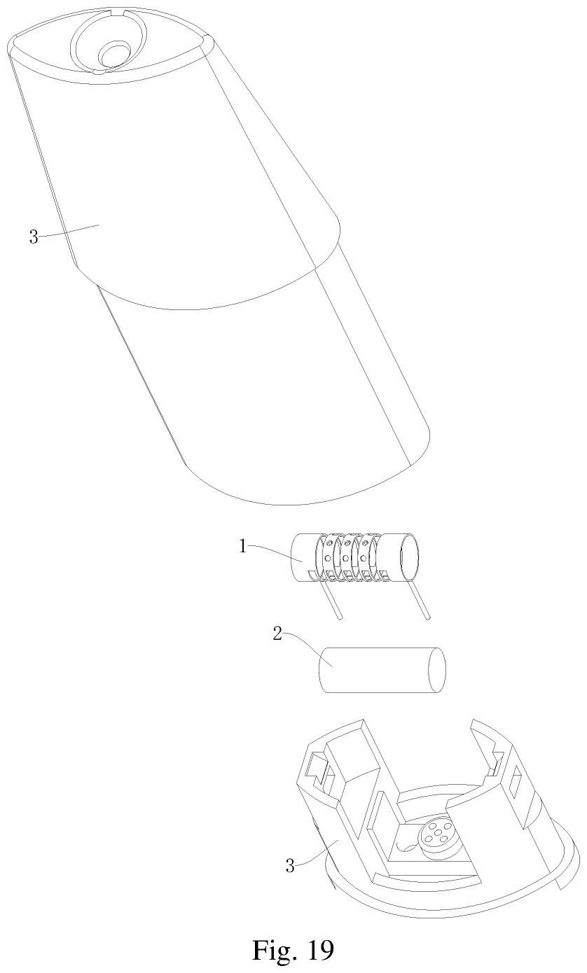

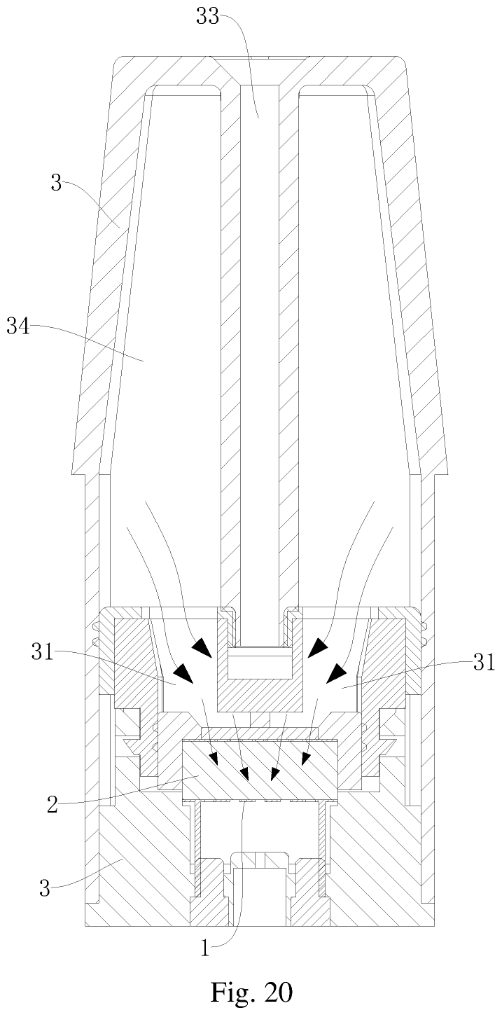

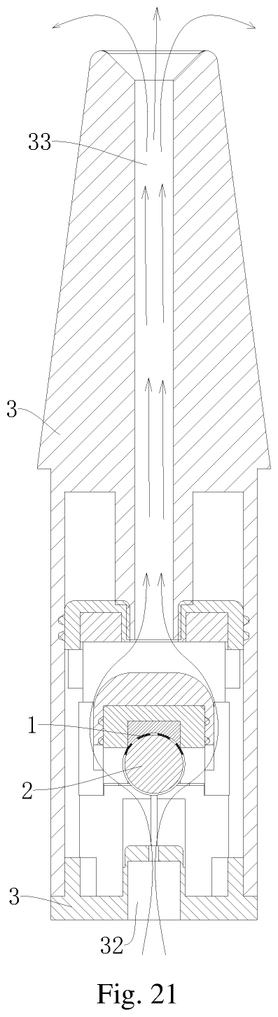

Referring to FIGS. 19 to 21, an atomizing device in an embodiment of the present invention includes the above-mentioned heating member 1, and further includes a housing 3 and a liquid conducting member 2. The liquid conducting member 2 is arranged in the heating member 1, and the housing 3 is provided with a liquid passage 31, an air inlet passage 32 and an air outlet passage 33, therein. The liquid storage chamber 34 may be arranged in the housing 3 or outside the housing 3, and communicated with the liquid passage 31. The liquid passage 31 and the air inlet passage 32 are respectively communicated to the radial two sides of the heating member 1. When the heating member is powered on, the heat value of the side of the heating member 1 to which the liquid passage 31 is communicated per unit time is less than that of the side of the heating member 1 to which the air inlet passage 32 is communicated per unit time. In the embodiment shown in FIGS. 19 to 21, the liquid passage 31 is communicated to the upper side of the heating member 1, the air inlet passage 32 is communicated to the lower side of the heating member 1, the liquid enters the liquid conducting member 2 through the upper side of the heating member 1, and the liquid conducting member 2 conducts the liquid to the heating member 1 for heating and atomizing. The external air flow enters the housing 3 through the air inlet passage 32, and flows by the heating member 1, then takes the atomized gas out of the housing 3 from the air outlet passage 33.

The liquid of the atomizing device is directly supplied from one radial side of the tubular heating member along the radial direction, with a shorter path and a more sufficient liquid supply. The lower side has a higher heating efficiency and is better matched with the air flow path, avoiding the problem of high heat in the upper surface that the air flow is not easy to pass by. The heat in the lower side of the heating member 1 will be transmitted to the upper side to preheat the smoke liquid, thereby reducing the kinematic viscosity of the smoke liquid, making the liquid supply more sufficient, and further preventing the problems of dry burning caused by insufficient liquid supply and some harmful substances produced caused by high temperature.

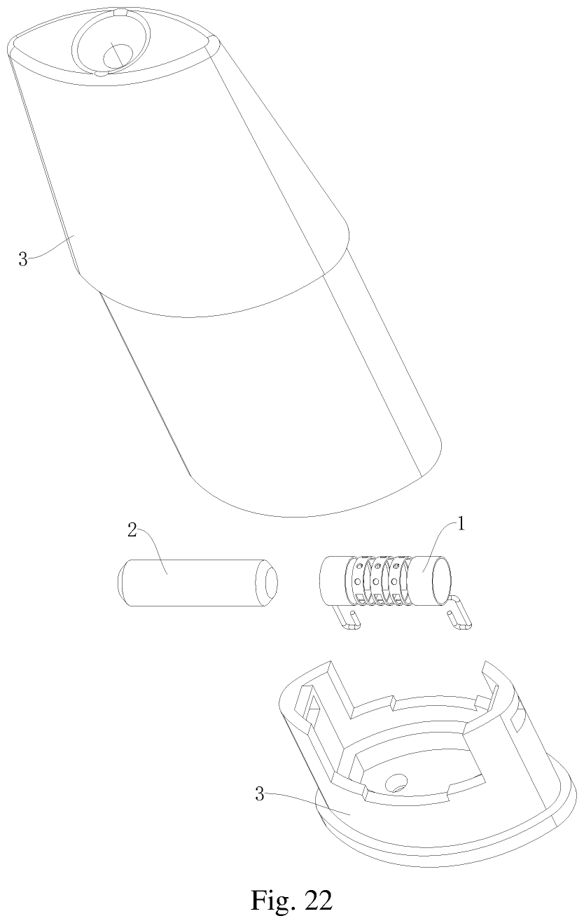

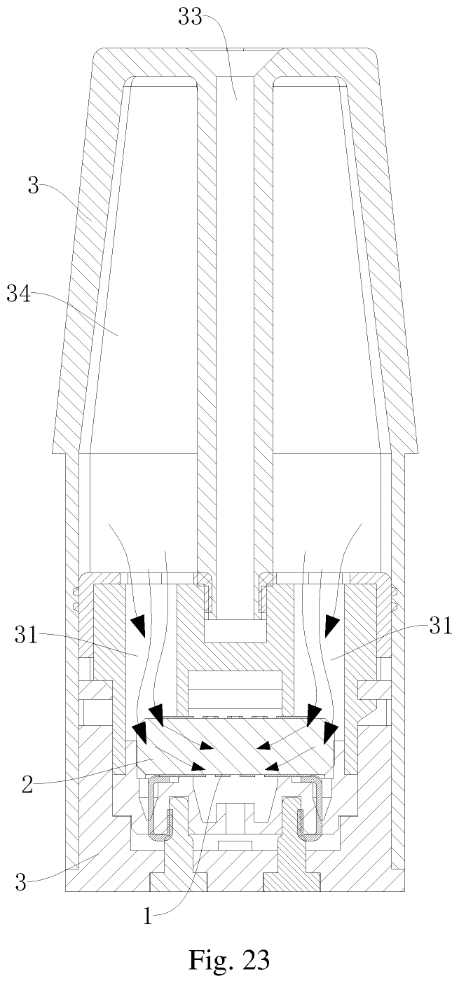

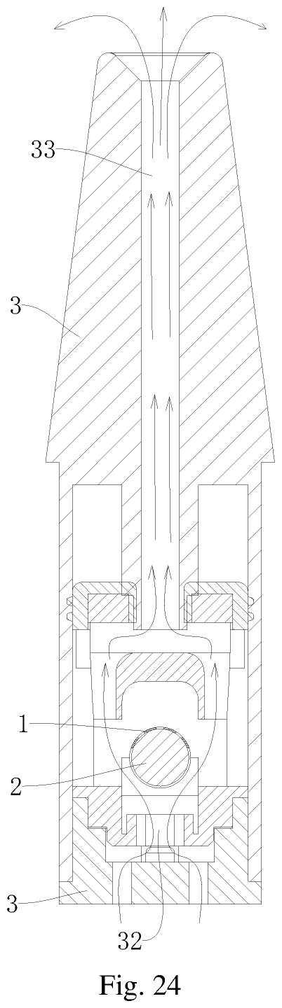

Referring to FIGS. 22 to 24, an atomizing device in another embodiment of the present invention includes the above heating member 1, and further includes a housing 3 and a liquid conducting member 2. The liquid conducting member 2 is disposed in the heating member 1 and extends beyond the heating member 1 at the two ends in the axial direction. The housing 3 is provided with a liquid passage 31, an air inlet passage 32 and an air outlet passage 33, therein. The liquid storage chamber 34 may be located in or outside the housing 3 and communicated with the liquid passage 31. The liquid passage 31 is communicated to the two ends of the liquid conducting member 2 that extend beyond the heating member 1, the air inlet passage 32 is communicated to a radial side of the heating member 1, and the heating value of the side of the heating member 1 to which the air inlet passage 32 is communicated per unit time is larger than that of the other side per unit time. In the embodiment of FIGS. 22 to 24, the air inlet passage 32 is communicated to the lower side of the heating member 1, and the other side is the upper side; the liquid is in contact with the two ends of the liquid conducting member 2, and the liquid conducting member 2 conducts the liquid to the heating member 1 for heating and atomizing. The external air flow enters the housing 3 through the air inlet passage 32, passes by the heating member 1, and takes the atomized gas out of the housing 3 through the air outlet passage 33.

Compared with the traditional liquid conducting cotton in the middle and the heating member wound around the outer periphery thereof, the traditional heating member generates heat in the full circumferential direction, and the air flow does not pass by rightly above the heating member, and the atomized steam with higher temperature is not bring out of the atomizing chamber, which will lead to poor atomization effect and some flavor of the smoke liquid will not come out. Besides, there is also the problem that the invalid heating area above wastes electric energy, causing a poor battery range. By designing the heat distribution of the tubular heating member 1, the atomizing device can match the heating atomizing surface with the liquid conducting member 2 by which the air flows, to achieve the effect of heat balance, so that the heat generated by the heating assembly is more balanced when the air flows during use, and the atomizing effect is good; in addition, the electric energy is saved, thus the battery lasts longer, and unnecessary energy waste is avoided.

The atomizing device of the invention may be applied to the electronic cigarette, the liquid storage chamber 34 is configured to store the smoke liquid, and the heating member 1 is configured to heat and atomize the smoke liquid.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

1. A heating member (1) of an atomizing device with different heating effects at different portions, configured to heat and atomize liquid, wherein the heating member (1) is tubular, with a radial dimension between 1 mm and 17 mm, an axial dimension between 2 mm and 33 mm, and a wall thickness between 0.02 mm and 0.9 mm,
wherein the heating member (1) comprises two electrode portions (12) respectively disposed at two ends in the axial direction and a heating circuit portion (11) electrically connected between the two electrode portions (12),
wherein the heating circuit portion (11) comprises a group of first connecting portions (111), a group of second connecting portions (112), a group of third connecting portions (113) and a group of fourth connecting portions (114) disposed sequentially in the circumferential direction,
wherein the group of first connecting portions (111) comprises a plurality of first connecting portions (111) spaced along the axial direction, the group of second connecting portions (112) comprises a plurality of second connecting portions (112) spaced along the axial direction, the group of third connecting portions (113) comprises a plurality of third connecting portions (113) spaced along the axial direction, and the group of fourth connecting portions (114) comprises a plurality of fourth connecting portions (114) spaced along the axial direction; and
wherein the axial dimensions of the first connecting portion (111) and the third connecting portion (113) are larger than the axial dimensions of the second connecting portion (112) and the fourth connecting portion (114), each first connecting portion (111) connects two adjacent second connecting portions (112) and two adjacent fourth connecting portions (114), each third connecting portion (113) connects two adjacent second connecting portions (112) and two adjacent fourth connecting portions (114), so that the first connecting portions (111), the second connecting portions (112) and the third connecting portions (113) are connected to form a first circuit (11a), and the third connecting portions (113), the fourth connecting portions (114) and the first connecting portions (111) are connected to form a second circuit (11b), and the first circuit (11a) is connected in parallel with the second circuit (11b), and when the electrode portions (12) are powered on, the first circuit (11a) and the second circuit (11b) generate heat, and the heat of a radial side of the heating member (1) per unit time is less than that of another radial side of the heating member (1) per unit time.

2. The heating member of claim 1, wherein the first connecting portions (111) are disposed on an axial a radial side, and the second connecting portions (112), the third connecting portions (113) and the fourth connecting portions (114) are disposed on another side,
wherein a circumferential sectional area of the first connecting portion (111) is larger than a circumferential sectional area of the third connecting portion (113), a circumferential dimension of the first connecting portion (111) is larger than circumferential dimensions of the second connecting portion (112), the third connecting portion (113) and the fourth connecting portion (114), and the heat of the first connecting portions (111) per unit time is less than the heats of the second connecting portions (112), the third connecting portions (113) and the fourth connecting portions (114) per unit time.

3. The heating member of claim 2, wherein from the middle to two ends of the heating member (1), the circumferential dimensions of the first connecting portions (111) are equal, the circumferential dimensions of the second connecting portions (112) are equal, and the circumferential dimensions of the fourth connecting portions (114) are equal; or,
the circumferential dimensions of the first connecting portions (111) increase, the circumferential dimensions of the second connecting portions (112) decrease, and the circumferential dimensions of the fourth connecting portions (114) decrease; or,
the circumferential dimensions of the first connecting portions (111) decrease, the circumferential dimensions of the second connecting portions (112) increase, and the circumferential dimensions of the fourth connecting portions (114) increase.

4. The heating member of claim 2, wherein the first connecting portion (111) is provided with a liquid inlet hole (1111) communicating the inside with the outside.

5. The heating member of claim 1, wherein a circumferential dimension of the second connecting portion (112) is larger than a circumferential dimension of the fourth connecting portion (114), and the heat of the second connecting portions (112) per unit time is smaller than the heat of the fourth connecting portions (114) per unit time.

6. The heating member of claim 5, wherein axial dimensions of the second connecting portion (112) and the fourth connecting portion (114) are equal.

7. The heating member of claim 1, wherein the second connecting portion (112) and the fourth connecting portion (114) are respectively disposed on two radial sides of the heating member (1), and
wherein an axial dimension of the second connecting portion (112) is smaller than an axial dimension of the fourth connecting portion (114), spacings between at least some of the second connecting portions (112) are larger than spacings between the fourth connecting portions (114), and the heat of the second connecting portions (112) per unit time is less than that of the fourth connecting portions (114) per unit time.

8. The heating member of claim 7, wherein circumferential dimensions of the second connecting portion (112) and the fourth connecting portion (114) are equal.

9. The heating member of claim 5, wherein circumferential dimensions of the first connecting portion (111) and the third connecting portion (113) are smaller than those of the second connecting portion (112) and the fourth connecting portion (114).

10. The heating member of claim 1, wherein circumferential dimensions of each second connecting portion (112), and/or each fourth connecting portion (114), and/or each first connecting portion (111), and/or each third connecting portion (113) are equal.

11. The heating member of claim 1, wherein the first connecting portion (111) and the third connecting portion (113) are staggered in the axial direction.

12. The heating member of claim 1, wherein the heating circuit portion (11) is connected to the two electrode portions (12) through the first connecting portion (111) or the third connecting portion (113).

13. An atomizing device, comprising:
the heating member (1) of claim 1;
a housing (3); and
a liquid conducting member (2);
wherein the liquid conducting member (2) is disposed in the heating member (1),
wherein the housing (3) is provided with a liquid passage (31) and an air inlet passage (32) therein,
wherein the liquid passage (31) and the air inlet passage (32) are communicated to two radial sides of the heating member (1) respectively, and
wherein the heat of the side of the heating member (1) communicated to the liquid passage (31) per unit time is less than the heat of the side of the heating member (1) communicated to the air inlet passage (32) per unit time.

14. An atomizing device, comprising:
the heating member (1) of claim 1;
a housing (3); and
a liquid conducting member (2);
wherein the liquid conducting member (2) is disposed in the heating member (1) with two ends in the axial direction extending out of the heating member (1),
wherein the housing (3) is provided with a liquid passage (31) and an air inlet passage (32) therein,
wherein the liquid passage (31) is communicated to the two ends of the liquid conducting member (2), and the air inlet passage (32) is communicated to a radial side of the heating member (1), and
wherein the heat of the side of the heating member (1) communicated to the air inlet passage (32) per unit time is larger than the heat of another side of the heating member (1).

15. The atomizing device of claim 13, wherein the first connecting portions (111) are disposed on a radial side, and the second connecting portions (112), the third connecting portions (113) and the fourth connecting portions (114) are disposed on another side,
wherein a circumferential sectional area of the first connecting portion (111) is larger than a circumferential sectional area of the third connecting portion (113), a circumferential dimension of the first connecting portion (111) is larger than circumferential dimensions of the second connecting portion (112), the third connecting portion (113) and the fourth connecting portion (114), and the heat of the first connecting portions (111) per unit time is less than the heats of the second connecting portions (112), the third connecting portions (113) and the fourth connecting portions (114) per unit time.

16. The atomizing device of claim 13, wherein a circumferential dimension of the second connecting portion (112) is larger than a circumferential dimension of the fourth connecting portion (114), and the heat of the second connecting portions (112) per unit time is smaller than the heat of the fourth connecting portions (114) per unit time.

17. The atomizing device of claim 13, wherein the second connecting portion (112) and the fourth connecting portion (114) are respectively disposed on two radial sides of the heating member (1), and
wherein an axial dimension of the second connecting portion (112) is smaller than an axial dimension of the fourth connecting portion (114), spacings between at least some of the second connecting portions (112) are larger than spacings between the fourth connecting portions (114), and the heat of the second connecting portions (112) per unit time is less than that of the fourth connecting portions (114) per unit time.

18. The atomizing device of claim 14, wherein the first connecting portions (111) are disposed on a radial side, and the second connecting portions (112), the third connecting portions (113) and the fourth connecting portions (114) are disposed on another side,
wherein a circumferential sectional area of the first connecting portion (111) is larger than a circumferential sectional area of the third connecting portion (113), a circumferential dimension of the first connecting portion (111) is larger than circumferential dimensions of the second connecting portion (112), the third connecting portion (113) and the fourth connecting portion (114), and the heat of the first connecting portions (111) per unit time is less than the heats of the second connecting portions (112), the third connecting portions (113) and the fourth connecting portions (114) per unit time.

19. The atomizing device of claim 14, wherein a circumferential dimension of the second connecting portion (112) is larger than a circumferential dimension of the fourth connecting portion (114), and the heat of the second connecting portions (112) per unit time is smaller than the heat of the fourth connecting portions (114) per unit time.

20. The atomizing device of claim 14, wherein the second connecting portion (112) and the fourth connecting portion (114) are respectively disposed on two radial sides of the heating member (1), and
wherein an axial dimension of the second connecting portion (112) is smaller than an axial dimension of the fourth connecting portion (114), spacings between at least some of the second connecting portions (112) are larger than spacings between the fourth connecting portions (114), and the heat of the second connecting portions (112) per unit time is less than that of the fourth connecting portions (114) per unit time.
